(19) United States
(12) Patent Application Publication
(10) Pub. No.: US 2026/0241950 A1
(43) Pub. Date: Aug. 20, 2026

(54) INFORMATION PROCESSING METHOD, INFORMATION PROCESSING DEVICE, AND STORAGE MEDIUM STORING INFORMATION PROCESSING PROGRAM

(71) Applicant: DENSO CORPORATION, Kariya-city (JP)

(72) Inventors: Takuma ARIO, Kariya-city (JP); Kengo KOSAKA, Kariya-city (JP)

(21) Appl. No.: 19/641,892

(22) Filed: Apr. 8, 2026

Related U.S. Application Data
(63) Continuation of application No. PCT/JP2024/036503, filed on Oct. 11, 2024.

(30) Foreign Application Priority Data
Oct. 19, 2023 (JP) 2023-180473

(51) Int. Cl. B60W 50/14; B60W 60/00

(52) U.S. Cl. CPC B60W 50/14; B60W 60/001; B60W 2050/146; B60W 2510/20; B60W 2520/10; B60W 2520/14; B60W 2540/215; B60W 2552/30; B60W 2556/40; B60W 2720/10

(57) ABSTRACT

An information processing device is configured to execute a route generation related process related to generation of route data defining a target route, accept an input of the target route targeted for each interval between nodes defining a passing position, and a target speed; and cause a display device to display the target route. The causing the display device to display the target route includes highlighting and displaying a non-permission section in the target route where a yaw rate falls outside a permission range permitting feasibility of tracing the target route.

### CROSS-REFERENCE TO RELATED APPLICATIONS

The present application is a continuation application of International Patent Application No. PCT/JP2024/036503 filed on Oct. 11, 2024, which designated the U.S. and claims the benefit of priority from Japanese Patent Application No. 2023-180473 filed on Oct. 19, 2023. The entire disclosures of all of the above applications are incorporated herein by reference.

### TECHNICAL FIELD

The present disclosure relates to an information technology for executing route generation related processing related to generation of route data defining a target route to be traced by an autonomous device capable of autonomous traveling.

### BACKGROUND

A travel trajectory correction device that corrects a travel trajectory of a vehicle has been known as a comparative example. When a deviation amount exceeds a threshold while the vehicle is traveling at a predetermined speed or higher, the travel trajectory correction device generates a correction trajectory smoothly connecting from a current position of the vehicle to a target point, and corrects the travel trajectory by replacing a portion up to the target point in the travel trajectory with the correction trajectory.

### SUMMARY

According to an aspect of the present disclosure, an information processing device may include at least one of (i) a circuit and (ii) a processor with a memory storing computer program code executable by the processor. The at least one of the circuit and the processor may be configured to cause the information processing device to: execute a route generation related process related to generation of route data defining a target route, accept an input of the target route targeted for each interval between nodes defining a passing position, and a target speed; and cause a display device to display the target route. The causing the display device to display the target route may include highlighting and displaying a non-permission section in the target route where a yaw rate falls outside a permission range permitting feasibility of tracing the target route.

### BRIEF DESCRIPTION OF THE DRAWINGS

FIG. 1 is a schematic diagram showing an autonomous device of a first embodiment.

FIG. 2 is a block diagram showing a configuration of an entire system including an information processing device of the first embodiment.

FIG. 3 is a block diagram showing a functional configuration of the information processing device according to the first embodiment.

FIG. 4 is a flowchart showing an information processing method according to the first embodiment.

FIG. 5 is a flowchart showing the information processing method according to the first embodiment.

FIG. 6 is a schematic diagram showing an example of a screen display in designing of a target route.

FIG. 7 is a schematic diagram showing an example of a screen display in designing of a target route.

FIG. 8 is a schematic diagram showing an example of highlighting.

FIG. 9 is a schematic diagram showing an example of a screen display in designing of a target route.

FIG. 10 is a graph showing an example of a change in yaw rate according to a distance from a start point node.

FIG. 11 is a flowchart showing an information processing method according to a second embodiment.

FIG. 12 is a flowchart showing an information processing method according to a third embodiment.

FIG. 13 is a schematic diagram showing an example of display of a limit route.

FIG. 14 is a schematic diagram showing an example of a screen display in designing of a target route.

FIG. 15 is a schematic diagram showing an example of display of a next limit route.

FIG. 16 is a flowchart showing an information processing method according to a fourth embodiment.

FIG. 17 is a flowchart showing an information processing method according to a fifth embodiment.

FIG. 18 is a schematic diagram showing an example of highlighting according to a sixth embodiment.

FIG. 19 is a schematic diagram showing an example of highlighting according to a seventh embodiment.

### DETAILED DESCRIPTION

In the technology of the comparative example, the travel trajectory is corrected after behavior in which the vehicle actually deviates from the travel trajectory occurs. In this case, there is a possibility that a trace delay with respect to the travel trajectory becomes large due to a response delay occurring from when the deviation is detected until the travel trajectory is corrected and the vehicle travels according to the corrected travel trajectory. On the other hand, in a case where route data defining a target route is generated in advance, if a user cannot grasp actual traceability as to whether the autonomous device can actually trace the designed target route, there is a possibility that convenience decreases.

An aspect of the present disclosure provides an information processing method capable of grasping actual traceability of an autonomous device with respect to a designed target route. Another aspect of the present disclosure provides an information processing apparatus capable of grasping actual traceability of an autonomous device with respect to a designed target route. Still another aspect of the present disclosure provides an information processing program capable of grasping actual traceability of an autonomous device with respect to a designed target route. Yet another aspect of the present disclosure provides a storage medium capable of grasping actual traceability of an autonomous device with respect to a designed target route.

According to a first aspect of the present disclosure, an information processing method is executed by a processor, and the information processing method includes: executing a route generation related process related to generation of route data defining a target route to be traced by an autonomous device capable of autonomous traveling; accepting an input of the target route targeted for each interval between a plurality of nodes defining a passing position of the autonomous device, and a target speed targeted in the autonomous traveling of the target route; and causing a display device to display the target route. The causing the display device to display the target route includes highlighting and displaying a non-permission section in the target route where a yaw rate, which is assumed for the autonomous device tracing the target route having a curved shape in correlation with the target route and the target speed, falls outside a permission range permitting feasibility of tracing the target route.

According to a second aspect of the present disclosure, an information processing device includes a processor configured to: execute a route generation related process related to generation of route data defining a target route to be traced by an autonomous device capable of autonomous traveling; accept an input of the target route targeted for each interval between a plurality of nodes defining a passing position of the autonomous device, and a target speed targeted in the autonomous traveling of the target route; and cause a display device to display the target route. The causing the display device to display the target route includes highlighting and displaying a non-permission section in the target route where a yaw rate, which is assumed for the autonomous device tracing the target route having a curved shape in correlation with the target route and the target speed, falls outside a permission range permitting feasibility of tracing the target route.

According to a third aspect of the present disclosure, an information processing program stored in a storage medium and including instructions to cause a processor to: execute a route generation related process related to generation of route data defining a target route to be traced by an autonomous device capable of autonomous traveling; accept an input of the target route targeted for each interval between a plurality of nodes defining a passing position of the autonomous device, and a target speed targeted in the autonomous traveling of the target route; and cause a display device to display the target route. The causing the display device to display the target route includes highlighting and displaying a non-permission section in the target route where a yaw rate, which is assumed for the autonomous device tracing the target route having a curved shape in correlation with the target route and the target speed, falls outside a permission range permitting feasibility of tracing the target route.

According to a fourth aspect of the present disclosure, a non-transitory computer-readable storage medium stores information processing program and including instructions to cause a processor to: execute a route generation related process related to generation of route data defining a target route to be traced by an autonomous device capable of autonomous traveling; accept an input of the target route targeted for each interval between a plurality of nodes defining a passing position of the autonomous device, and a target speed targeted in the autonomous traveling of the target route; and cause a display device to display the target route. The causing the display device to display the target route includes highlighting and displaying a non-permission section in the target route where a yaw rate, which is assumed for the autonomous device tracing the target route having a curved shape in correlation with the target route and the target speed, falls outside a permission range permitting feasibility of tracing the target route.

According to these first to fourth aspects, the non-permission section in the target route where the yaw rate assumed for the autonomous device tracing the curved target route in correlation with the target route and the target speed falls outside the permission range for trace feasibility is highlighted. Therefore, by checking the highlighted non-permission section, the user can grasp that the autonomous device cannot trace the inputted target route. Accordingly, it is possible to grasp the actual traceability.

Hereinafter, a plurality of embodiments of the present disclosure will be described based on the drawings. Note that identical reference signs may be assigned to corresponding components in each embodiment, and overlapping descriptions may be omitted. In addition, when only a part of a configuration is described in each embodiment, configurations of other embodiments described previously can be applied to other parts of the configuration. Furthermore, not only combinations of configurations explicitly stated in the description of each embodiment, but also configurations of a plurality of embodiments can be partially combined with each other even if not explicitly stated, provided that no particular difficulty arises in the combination.

### First Embodiment

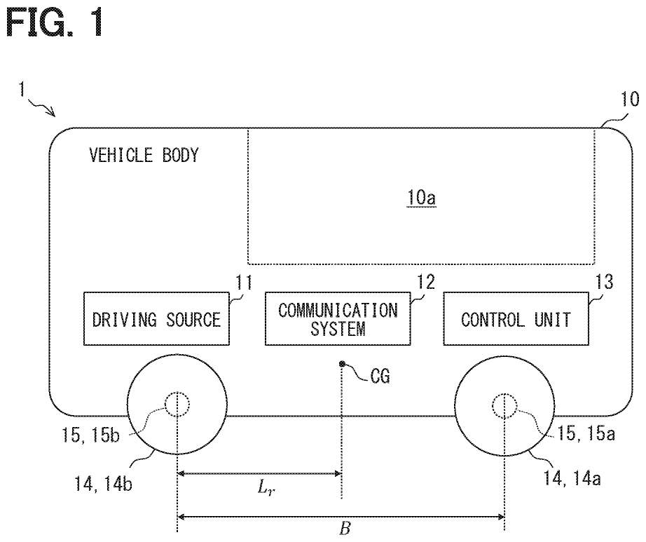

An information processing device 100 of a first embodiment controls display related to a target route P of an autonomous device 1 shown in FIG. 1. The autonomous device 1 is an autonomous device (autonomous robot) capable of autonomous traveling in arbitrary directions of front, rear, left, and right. Note that the autonomous device 1 as an autonomous device in the first embodiment may also be referred to as an autonomous vehicle. The autonomous device 1 is, for example, a transport vehicle that transports a load by autonomous traveling. Note that the autonomous device 1 may be used for purposes other than transporting loads (for example, information collection, etc.).

The autonomous device 1 is provided with a drive source 11, a control unit 13, wheels 14, and an axle 15 on a vehicle body 10. The drive source 11 is, for example, an electric motor or the like. A communication system 12 acquires communication information usable by the control unit 13 via wireless communication. The communication system 12 may be of a positioning type that receives positioning signals from artificial satellites of a GNSS (Global Navigation Satellite System) existing in an external world of the autonomous device 1. The positioning type communication system 12 is, for example, a GNSS receiver or the like. The communication system 12 may be of a V2X type that transmits and receives communication signals to and from a V2X system existing in the external world of the autonomous device 1. The V2X type communication system 12 is, for example, at least one type among a DSRC (Dedicated Short Range Communications) communication device, a Cellular V2X (C-V2X) communication device, and the like. The communication system 12 may be of a terminal communication type that transmits and receives communication signals to and from a terminal existing in an internal world or the external world of the autonomous device 1. The terminal communication type communication system 12 is, for example, at least one type among a Bluetooth (registered trademark) device, a Wi-Fi device, an infrared communication device, and the like.

The control unit 13 is a control device that executes autonomous traveling control of the autonomous device 1, and is an ECU (Electronic Control Unit) including at least one dedicated computer. The control unit 13 causes the autonomous device 1 to perform self-traveling by autonomously executing acceleration/deceleration control and steering control of the autonomous device 1. The control unit 13 controls autonomous traveling so as to trace the target route P according to route data related to the target route P.

The wheels 14 include a pair of front wheels 14a provided at a front portion of the vehicle body 10 and a pair of rear wheels 14b provided at a rear portion. The axle 15 includes a front axle 15a to which the pair of front wheels 14a are rotatably fixed at both ends thereof, and a rear axle 15b to which the pair of rear wheels 14b are rotatably fixed at both ends thereof. A loading space 10a for loading a load is provided in the vehicle body 10. The loading space 10a is formed, for example, as a space opened upward, with front, rear, left, and right sides partitioned by a part of the vehicle body 10. The loading space 10a may be formed, for example, as a space opened to a side of the vehicle body 10, or may simply be a space above an upper surface serving as a loading surface of the vehicle body 10.

The autonomous device 1 implements autonomous traveling by traveling so as to trace the target route P set in advance between a departure point and an arrival point. Note that the autonomous device 1 may be capable of manual traveling by a user operation in addition to autonomous traveling. For example, the autonomous device 1 may be provided with a driver's seat on the vehicle body 10 and be capable of manual traveling by operation of an operation system by a user seated in the driver's seat. The operation system is, for example, a steering member, an accelerator pedal, a brake pedal, and the like provided on the vehicle body 10. Alternatively, the autonomous device 1 may be capable of manual traveling by operation of a control pad as an operation system from outside or inside the vehicle body 10.

The information processing device 100 executes display for determining the target route P in advance to the user of the autonomous device 1 before departure of the autonomous device 1. Specifically, the information processing device 100 displays a limit route PL, for which tracing by the autonomous device 1 is permitted, to the user.

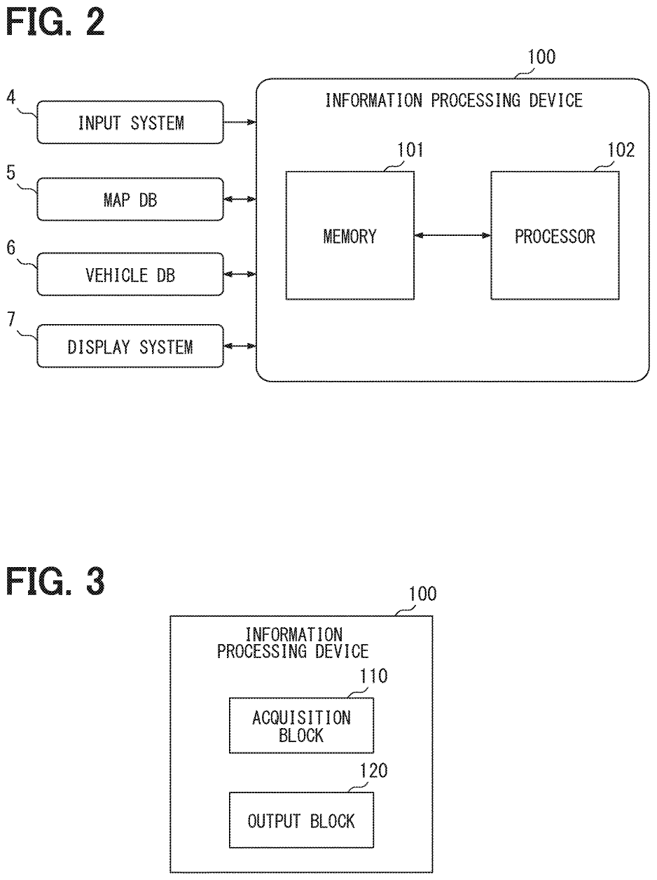

As shown in FIG. 2, the information processing device 100 is connected to an input system 4, a map database (DB) 5, a vehicle DB 6, and a display system 7 via at least one type among, for example, a LAN (Local Area Network) line, a wire harness, an internal bus, a wireless communication line, and the like.

The input system 4 accepts an input operation by the user. The input system 4 is, for example, at least one type among a mouse, a trackball, a keyboard, a touch panel, and the like.

The map DB 5 stores map information usable by the information processing device 100. The map DB 5 is configured to include at least one type of non-transitory tangible storage medium among, for example, a semiconductor memory, a magnetic medium, and an optical medium. The map DB 5 may be a database of a locator that estimates a self-state quantity including a self-position of a host vehicle A. The map DB 5 may be a database of a navigation unit that navigates a traveling route of the host vehicle A. The map DB 5 may be configured by a combination of a plurality of types among these databases and the like.

The map information in the map DB 5 includes at least horizontal two-dimensional position information regarding a periphery object O, which is an installed object in a facility area and can be an obstacle when the autonomous device 1 travels. For example, the map information may be point cloud data including a reflection point cloud of the periphery object O acquired by an external sensor such as LiDAR (Light Detection and Ranging/Laser Imaging Detection and Ranging). In this case, each reflection point has position information. Alternatively, the map information may be image data obtained by imaging the reflection point cloud projected onto a bird's-eye view plane. Note that the map information may have three-dimensional position information including height information of the periphery object O.

The vehicle DB 6 stores information regarding the autonomous device 1 (vehicle information) usable by the information processing device 100. The vehicle DB 6 includes at least one type of non-transitory tangible storage medium among, for example, a semiconductor memory, a magnetic medium, an optical medium, and the like. The vehicle information in the vehicle DB 6 includes information of the autonomous device 1 necessary for displaying the limit route PL. For example, the vehicle information includes dimension information of the autonomous device 1. The dimension information includes at least a distance Lr from a center of gravity position CG of the vehicle to the rear axle 15b.

The vehicle DB 6 stores the dimension information in association with identification information of the autonomous device 1. Here, the identification information is information indicating a vehicle type of the autonomous device 1, such as a product name, a model number, or a model name. That is, the vehicle DB 6 stores various information such that the dimension information corresponding to the vehicle type can be collated against designation of the vehicle type of the autonomous device 1.

The display system 7 is a display device that displays information to the user. Specifically, the display system 7 displays the target route P together with the map information of a target area. The display system 7 is, for example, at least one type such as a liquid crystal panel and an organic EL panel.

The information processing device 100 is a computer including at least one memory 101 and at least one processor 102. The memory 101 is at least one type of non-transitory tangible storage medium, such as a semiconductor memory, a magnetic medium, and an optical medium, that non-temporarily stores programs, data, and the like readable by the computer. Here, storage may be accumulation in which data is retained even when the computer is powered off, or may be temporary storage in which data is erased when the computer is powered off. The processor 102 includes at least one type among, for example, a CPU (Central Processing Unit), a GPU (Graphics Processing Unit), a RISC (Reduced Instruction Set Computer)-CPU, a DFP (Data Flow Processor), a GSP (Graph Streaming Processor), and the like as a core.

In the information processing device 100, the processor 102 executes a plurality of instructions included in an information processing program stored in the memory 101 to control display of route data defining the target route P to be traced by the autonomous device 1. Thereby, the information processing device 100 constructs a plurality of functional blocks for controlling the display of the route data defining the target route P to be traced by the autonomous device. The plurality of functional blocks constructed in the information processing device 100 include an acquisition block 110 and an output block 120 as shown in FIG. 3.

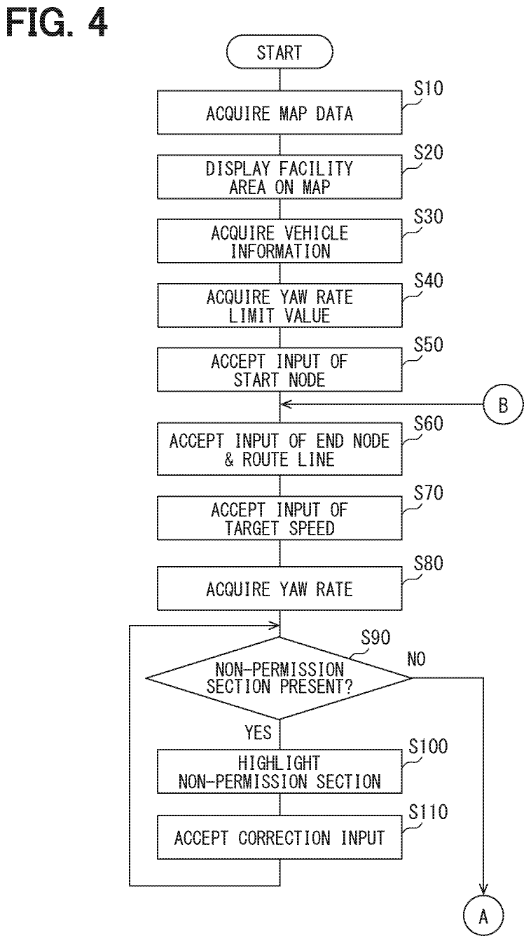

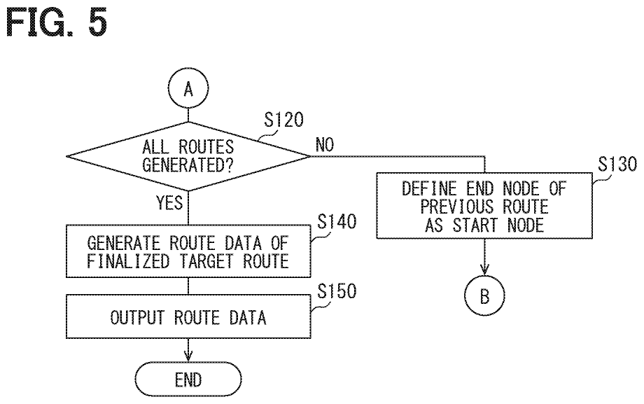

A flow of an information processing method in which the information processing device 100 controls display of route data defining the target route P to be traced by the autonomous device 1 through cooperation of these blocks 110 and 120 will be described below with reference to FIGS. 4 and 5. Hereinafter, this processing flow may be referred to as an information processing flow. This processing flow is repeatedly executed while the computer of the information processing device 100 is running. Note that each “S” in this processing flow means a plurality of steps executed by a plurality of instructions included in the information processing program.

First, in S10, the acquisition block 110 acquires map information about a facility area where the autonomous device 1 is used from the map DB 5. In subsequent S20, the output block 120 images the acquired map information and causes the display system 7 to display it as a map of the facility area. In this facility map, at least the periphery object O such as a building or an installed object that can be an obstacle when the autonomous device 1 travels is displayed. Road markings and the like may be further displayed on the facility map.

Then, in S30, the acquisition block 110 acquires vehicle information of the autonomous device 1. Specifically, the acquisition block 110 accepts an input of identification information by the user via the input system 4, and reads vehicle information of the autonomous device 1 corresponding to the identification information from the vehicle DB 6.

In subsequent S40, the acquisition block 110 acquires a yaw rate limit value γₘₐₓ. The yaw rate limit value γₘₐₓ is a magnitude of a yaw rate γᵢ that defines a permission range for feasibility of a trace, which will be described later. In other words, the yaw rate limit value γₘₐₓ is a threshold defining an upper limit of the magnitude of the yaw rate γᵢ permitted for the autonomous device 1. That is, the yaw rate limit value γₘₐₓ is a value assumed as a value at which tracing of the target route P becomes substantially impossible when traveling at the yaw rate γᵢ larger than this or equal to or larger than this. The acquisition block 110 acquires the yaw rate limit value γₘₐₓ, for example, by accepting an input of the yaw rate limit value γₘₐₓ by the user via the input system 4. Alternatively, the yaw rate limit value γₘₐₓ may be a value defined in advance and stored in the memory 101 or the like.

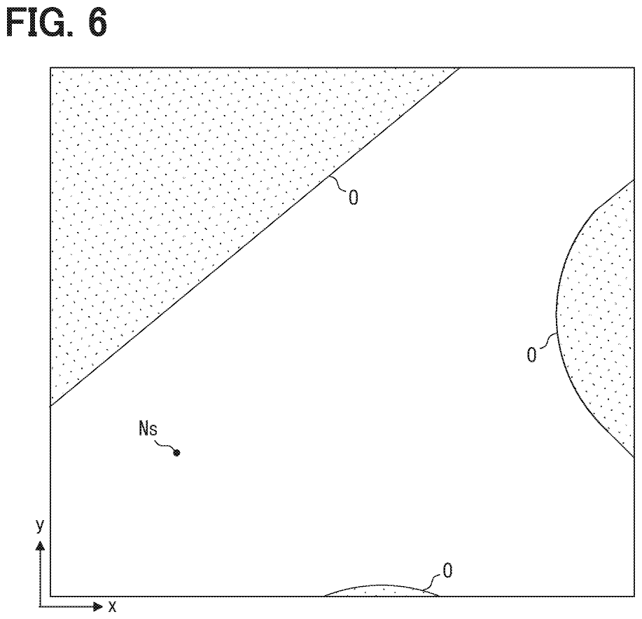

Then, in S50, the acquisition block 110 accepts an input of a start point node Ns by the user via the input system 4 as shown in FIG. 6. The start point node Ns is a start point of the target route P and is a node defining a passing position of the autonomous device 1 on the facility map. For example, the acquisition block 110 accepts the input of the start point node Ns by a click with a mouse, coordinate input with a keyboard, or the like with respect to an arbitrary position on the facility map.

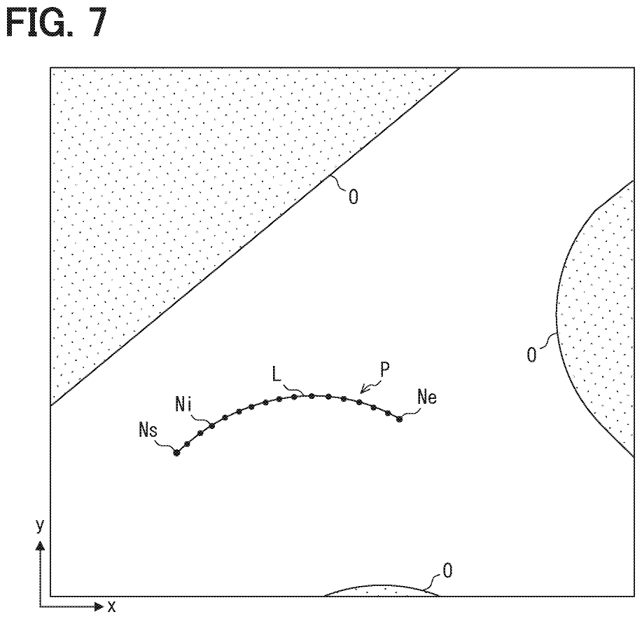

Next, in S60, the acquisition block 110 accepts an input of an end point node Ne by the user as shown in FIG. 7, and a route line L connecting the start point node Ns and the end point node Ne. The end point node Ne is an end point of the target route P and is a node defining a passing position of the autonomous device 1 on the facility map similarly to the start point node Ns. Also, the route line L is a linear object that connects the start point node Ns and the end point node Ne and defines a passing position of the autonomous device 1 between the nodes Ns and Ne.

By defining the start point node Ns and the end point node Ne on the displayed facility map by the user's mouse click, coordinate input, or the like, the route line L connecting the nodes Ns and Ne is also automatically input on the facility map. For example, the target route P is displayed as an image object in a vector format having at least the start point node Ns and the end point node Ne as vertices.

Therefore, by the user changing positions of these vertices or a direction and a magnitude of a vector from the vertices, a shape of the target route P is changed to what the user desires. The direction and magnitude of the vector from the vertices can be changed, for example, by operating a linear handle (not shown) extending from these vertices with a mouse or the like. Note that vertices defining the shape of the target route P other than the nodes Ns and Ne may be arbitrarily added by the user. In the present embodiment, the target route P is designed by such input operations by the user. Through the processes of S40 and S50 described above, the target route P is defined by the start point node Ns, the end point node Ne, and the route line L.

In subsequent S70, the acquisition block 110 acquires a target speed Vᵢ in the autonomous device 1. The target speed Vᵢ is a traveling speed targeted by the autonomous device 1 when traveling the target route P scheduled to be input. The acquisition block 110 acquires the target speed Vᵢ, for example, by accepting an input of the target speed Vᵢ via the input system 4. Alternatively, the acquisition block 110 may accept an input by reading the target speed Vᵢ defined in advance from a storage medium such as the memory 101. The acquisition block 110 acquires a plurality of target speeds Vᵢ for one target route P, for example, by accepting an input of the target speed Vᵢ for each predetermined position on the target route P.

Specifically, the acquisition block 110 accepts inputs of the target speed Vi at the start point node Ns, the end point node Ne, and a plurality of intermediate nodes Ni set on the route line between the nodes Ns and Ne. Note that the target speed Vᵢ may be individually input by the user for each one of all nodes. The target speed Vᵢ may be input by the user for one or more representative nodes. In this case, target speeds Vᵢ of nodes other than the representative nodes may be interpolated based on the target speed Vᵢ of the representative node. Alternatively, the target speed Vᵢ may be a uniform value input by the user for each set of a plurality of nodes. Note that the acquisition block 110 may accept an input of one target speed Vᵢ for the entire target route P.

In subsequent S80, the acquisition block 110 acquires the yaw rate γᵢ assumed for the autonomous device 1 tracing the curved target route P in correlation with the target route P and the target speed Vᵢ. The acquisition block 110 acquires a plurality of yaw rates γᵢ for each node of the target route P. Specifically, the acquisition block 110 respectively acquires the yaw rate γᵢ correlated with a curvature ρᵢ of the target route P at each node and the target speed Vi.

Here, the curvature ρᵢ of the target route P at each node is a value correlated with a coordinate position xᵢ, yᵢ and a yaw angle φᵢ of each node. Note that the yaw angle φᵢ is an angle formed by a tangent line of the target route P at the coordinate position (xᵢ, yᵢ) and the x-axis. A relationship of the following first equation is established between the curvature ρᵢ, and coordinate position xₖ, yₖ and yaw angle φₖ. Also, a relationship of the following second equation is established between the yaw rate γᵢ, and the curvature ρᵢ and the target speed Vᵢ.

$${ρ}_{i} = \frac{{ϕ}_{i} - {ϕ}_{i - 1}}{\sqrt{{( {x}_{i} - {x}_{i - 1} )}^{2} + {( {y}_{i} - {y}_{i - 1} )}^{2}}} \qquad ( First Equation )$$

$${γ}_{i} = {ρ}_{i} {V}_{i} \qquad ( Second Equation )$$

Therefore, in order to acquire the yaw rate γᵢ, the acquisition block 110 calculates the curvature ρᵢ based on the first equation for each node, and then calculates the yaw rate γᵢ based on the second equation.

In subsequent S90, the output block 120 determines presence or absence of a non-permission section S in the target route P where the yaw rate γᵢ falls outside a permission range allowing feasibility of tracing the target route by the autonomous device 1. For example, the permission range is a range of the yaw rate γᵢ whose magnitude, that is, absolute value falls within an upper limit. Note that, here, the magnitude falling within the upper limit means that the magnitude is equal to or less than, or less than, a threshold.

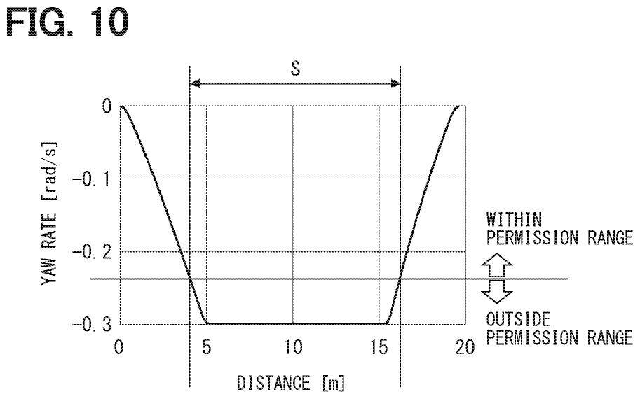

For example, assume that for a certain target route P, the yaw rate γᵢ at each node according to a distance from the start point node Ns has a relationship shown in the graph of FIG. 10. When there is a distance section where the yaw rate γᵢ is outside the permission range shown in FIG. 10, the output block 120 identifies the section as the non-permission section S in the target route P. A section where the yaw rate γᵢ is within the permission range in the target route P can also be referred to as a permission section with respect to the non-permission section S. Note that a distance Di from the start point node Ns to each node is represented by the following third equation, for example, as a sum of distances between respective nodes.

$${D}_{i} = {\sum }_{k = 1}^{i} \sqrt{{( {x}_{k} - {x}_{k - 1} )}^{2} + {( {y}_{k} - {y}_{k - 1} )}^{2}} \qquad ( Third Equation )$$

When it is determined that the non-permission section S exists, this flow proceeds to S100. In S90, the output block 120 highlights the non-permission section S in the target route P displayed on the display system 7 more than other sections. For example, highlighting includes displaying by changing at least one of a display color, a line type, and a thickness of a line with respect to other sections.

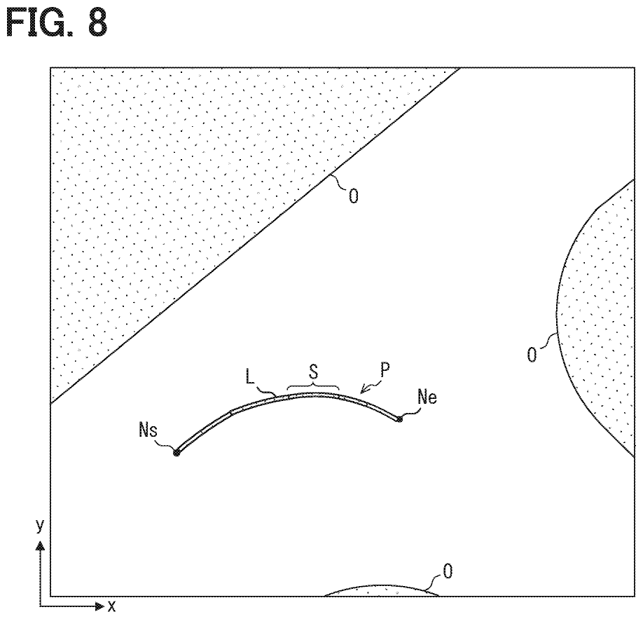

As an example, the output block 120 causes the target route P to be displayed in a display color corresponding to a difference of the target speed Vᵢ with respect to a speed upper limit at which the yaw rate γᵢ falls within the permission range. Thereby, the target route P in a heat map form is displayed on the display system 7 as shown in FIG. 8. Note that in FIG. 8, a difference in display color is expressed by shading of dot hatching, and the non-permission section S where the target speed Vᵢ exceeds the speed upper limit is expressed by the darkest dot hatching. In this way, the output block 120 allows the user to grasp the non-permission section S where the target speed Vᵢ exceeds the speed upper limit by the display color. The output block 120 may display a correspondence image showing correspondence between the difference and the display color. By such highlighting related to the target speed Vᵢ, the output block 120 proposes a reduction in the target speed Vᵢ. Thereby, the output block 120 prompts the user to eliminate the non-permission section S by lowering the target speed Vᵢ.

In subsequent S110, the acquisition block 110 accepts a correction input regarding the non-permission section S. For example, the acquisition block 110 accepts a correction input for lowering the target speed Vi by the user via the input system 4 for each node of the non-permission section S. The acquisition block 110 may accept a manual change input of the target speed Vᵢ by the user as the correction input. Alternatively, the acquisition block 110 may accept a user's permission input regarding correction of the target speed Vᵢ as the correction input, and automatically correct the target speed Vᵢ to a speed falling within the speed upper limit.

When the correction input is accepted and the target speed Vᵢ is corrected, this flow returns to S90. That is, the processes of S90, S100, and S110 are repeated until the non-permission section S disappears from the target route P by the correction of the target speed Vᵢ. When it is determined in S90 that there is no non-permission section S in the target route P, this flow proceeds to S120 in FIG. 5.

In S120, the acquisition block 110 determines whether generation of the entire target route P up to a final arrival point is completed. For example, the acquisition block 110 determines that the target route P has been finalized when accepting an input by which the user decides completion of generation of the target route P via the input system 4. If it is determined that the generation of the entire target route P is incomplete, this flow proceeds to S130.

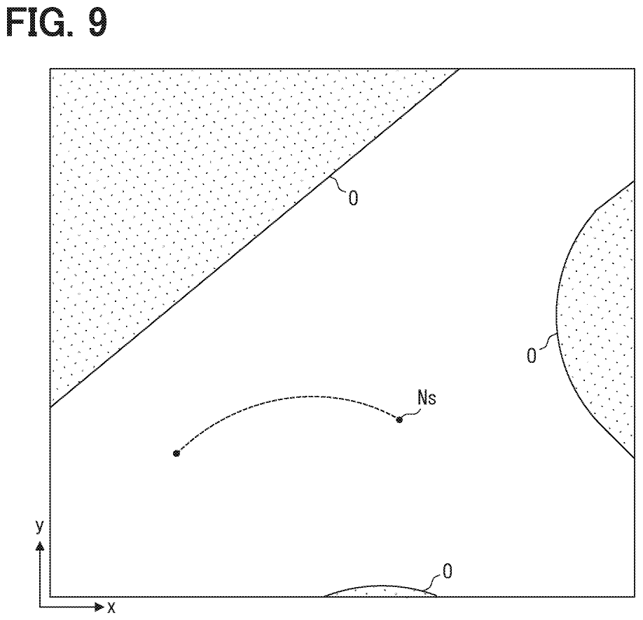

In S130, the acquisition block 110 defines the end point node Ne of the target route P input in immediately preceding S60 as a start point node Ns of a target route P for which input is to be accepted next, as shown in FIG. 9. Specifically, the acquisition block 110 reads coordinates of the end point node Ne of the immediately preceding target route P as a coordinate position of the next start point node Ns. Thereafter, this flow returns to S60.

On the other hand, if it is determined in S120 that the generation of the entire target route P is completed, this flow proceeds to S140. In S140, the output block 120 generates route data in which the target route P is finalized. The route data may be data of the target route P alone. The data of the target route P alone includes, for example, at least position coordinates of each node in the target route P. The route data may be data combining the target route P and the facility map. In S140, the route data regarding the finalized target route P is output. The route data is output, for example, by storage in a storage medium such as the memory 101 or an external memory, transmission of the route data to the autonomous device 1, or the like. The information processing device 100 repeats the above processes until the user sets the target route P up to the final arrival point of the autonomous device 1.

According to the first embodiment described above, the non-permission section S where the yaw rate γᵢ assumed for the autonomous device 1 tracing the target route P having a curved shape in correlation with the target route P and the target speed Vᵢ falls outside the permission range for trace feasibility is highlighted. Therefore, by checking the highlighted non-permission section S, the user can grasp that the autonomous device cannot trace the inputted target route. Accordingly, the actual traceability can be grasped.

Further, according to the first embodiment, the input of the target route P designed by manual input of nodes by the user on the facility map displayed on the display system 7 is accepted. Therefore, by checking presence or absence of highlighting of the non-permission section S for the target route P designed by manually inputting nodes, the user can determine whether the autonomous device 1 can trace the target route P in autonomous traveling.

Furthermore, according to the first embodiment, highlighting the non-permission section S includes proposing a reduction in the target speed Vᵢ in the non-permission section S. According to this, it is possible to propose easier elimination of the non-permission section S to the user without causing the user to change the shape of the target route P.

Further, according to the first embodiment, route data defining the target route P in which the non-permission section S is eliminated is generated. According to this, it is possible to reliably generate route data with high actual traceability.

In addition, according to the first embodiment, route data defining the target route P in which the non-permission section S is eliminated is output. According to this, it is possible to implement stable autonomous traveling of the autonomous device 1 by the output route data with high actual traceability.

### Second Embodiment

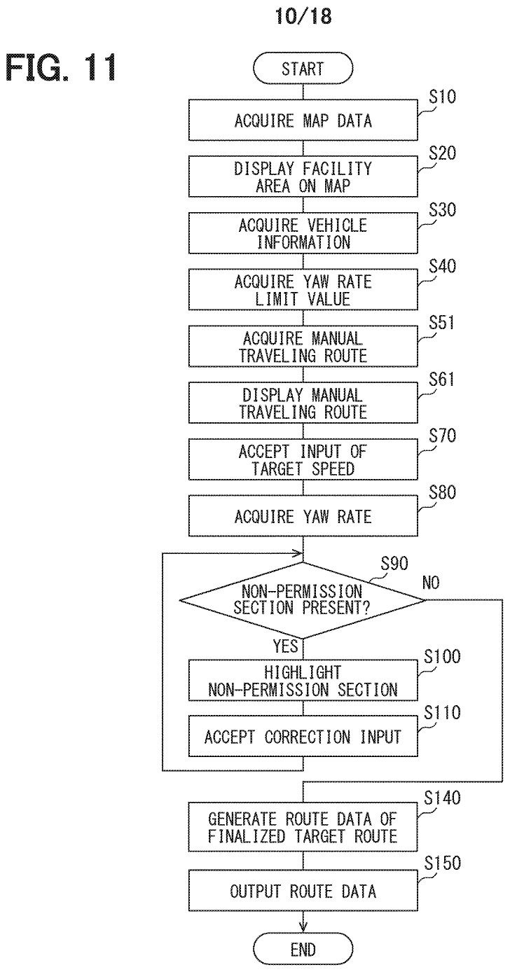

As shown in FIG. 11, a second embodiment is a modification of the first embodiment.

A flow of an information processing method in the second embodiment proceeds to S51 after the process of S40, as shown in FIG. 11. In S51, the acquisition block 110 acquires manual driving route data. The manual driving route data is data regarding a route actually traveled by the autonomous device 1 by manual driving. The manual driving route data includes at least position coordinate data at each position on the route. The acquisition block 110 accepts an input of the manual driving route data by wireless or wired communication with the autonomous device 1, reading of a storage medium such as a memory card in which data is written, or the like. In the present embodiment, the target route P is designed by such acquisition processing of the manual route data. Note that the acquisition block 110 may acquire the manual driving route data from the departure point to the arrival point at once. Alternatively, the acquisition block 110 may acquire manual driving route data for each of a plurality of sections from the departure point to the arrival point in multiple times.

In subsequent S61, the output block 120 causes the display system 7 to display the manual driving route data. The output block 120 causes the route by manual driving to be displayed as the target route P by converting coordinate position data in the manual driving route data into coordinate position data on the facility map.

According to the second embodiment described above, input of the target route P as the manual driving route data regarding the route in which the autonomous device 1 actually travels by manual driving is accepted. By checking presence or absence of highlighting of the non-permission section S, the user can determine whether the autonomous device 1 can trace the manual driving route data in autonomous traveling. Thereby, it can become possible to avoid impossibility of tracing substantially the same route as the manual driving due to performance constraints or the like regarding autonomous traveling in the autonomous device 1.

### Third Embodiment

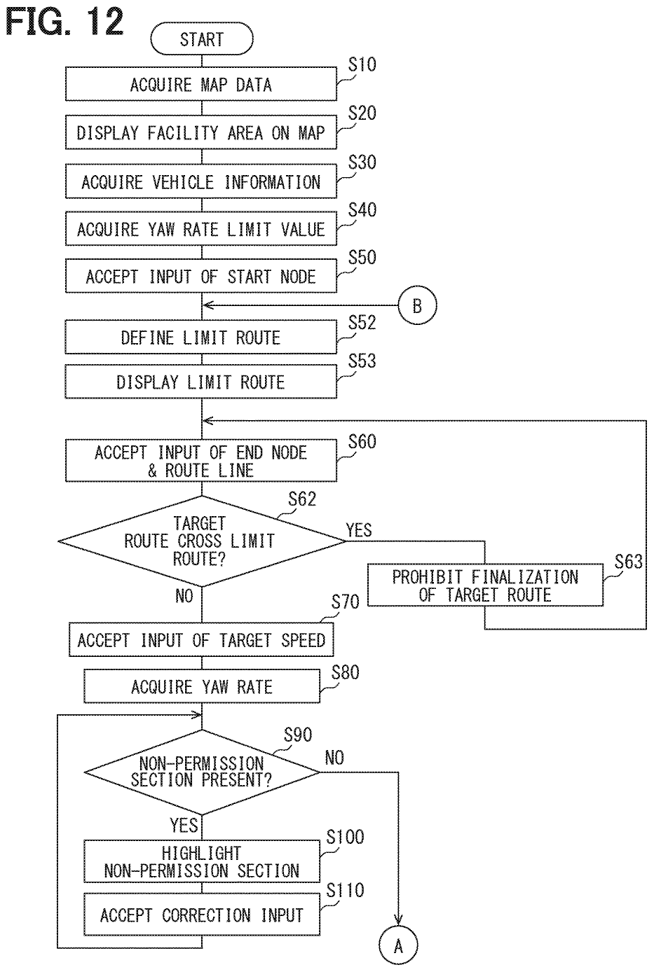

As shown in FIGS. 12 to 15, a third embodiment is a modification of the first embodiment.

A flow of an information processing method in the third embodiment proceeds to S52 after the process of S50, as shown in FIG. 12. In S52, the output block 120 defines the limit route PL extending from the start point node Ns. The limit route PL is a curved route that is a limit at which tracing of the target route P by the autonomous device 1 is permitted. The limit route PL is a route correlated with a yaw rate limit value, which is an upper limit within the permission range where tracing is established, and a set speed Vs. In other words, the limit route PL is a route defined according to the yaw rate limit value and the set speed Vs. Specifically, the limit route PL is a route further defined according to vehicle information. The set speed Vs is, for example, an upper limit speed of the autonomous device 1 when traveling the target route P scheduled to be input. The set speed Vs may be input by the user or may be a value defined in advance. The set speed Vs may be a speed that differs according to a distance from the start point node Ns, or may be a uniform speed.

To define the limit route PL, the output block 120 simulates a coordinate position and transition of a yaw angle when the autonomous device 1 performs curve traveling (turning traveling) so as to maintain the yaw rate limit value at the set speed Vs from the position of the start point node Ns. The coordinate system here is an orthogonal coordinate system fixed with respect to a road surface. The output block 120 adopts a travel trajectory as a result of the simulation as the limit route PL. The output block 120 executes simulation for each of a case of right turning traveling and a case of left turning traveling from the position of the start point node Ns, and defines two patterns of limit routes PL. Note that left and right here mean left and right when facing a traveling direction of the autonomous device 1.

For example, the output block 120 simulates traveling of the autonomous device 1 using a two-wheel model regarding the autonomous device 1 as a two-wheeled vehicle including a virtual front wheel and rear wheel. The output block 120 updates the coordinate position xₖ, yₖ and yaw angle φₖ of the traveling autonomous device 1 for every predetermined time step ds. Here, a subscript k in xₖ, yₖ, φₖ is a natural number where k=0 at an initial position, that is, the start point node Ns, and increases by 1 for each update.

A slip angle β in the autonomous device 1 having the distance Lr from the center of gravity position CG to the rear axle 15b, turning at the set speed Vs and the yaw rate limit value γₘₐₓ, corresponds to the following fourth equation. Note that positive and negative of the right side in the first equation is selectively determined by a turning direction.

$$β = \pm \frac{{L}_{r}}{{V}_{s}} {γ}_{max} \qquad ( Fourth Equation )$$

Then, a position (xₖ₊₁, yₖ₊₁) and a yaw angle φₖ₊₁ after the time step ds from the position (xₖ, yₖ) and the yaw angle φₖ correspond to the following fifth to seventh equations.

$${x}_{k + 1} = {x}_{k} + cos ( {ϕ}_{k} + β ) \cdot ds \qquad ( Fifth Equation )$$

$${y}_{k + 1} = {y}_{k} + sin ( {ϕ}_{k} + β ) \cdot ds \qquad ( Sixth Equation )$$

$${ϕ}_{k + 1} = {ϕ}_{k} + \frac{{γ}_{max}}{{V}_{s}} \cdot ds \qquad ( Seventh Equation )$$

The output block 120 acquires a set of coordinate positions (xₖ, yₖ) of the autonomous device 1 when turning while maintaining the yaw rate limit value as a travel trajectory by executing updates an arbitrary number of times. Note that the time step ds and the number of updates may be settable by the user, respectively, or may be defined in advance.

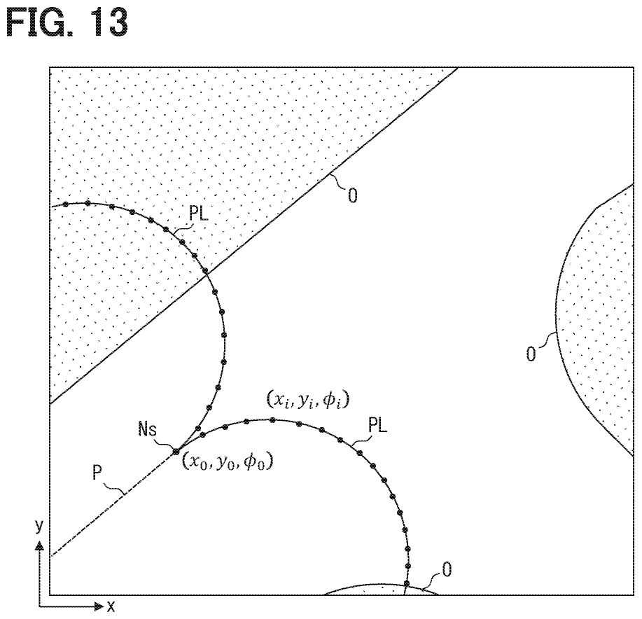

In subsequent S53, the output block 120 displays the limit route PL on the display system 7 as shown in FIG. 13. The output block 120 displays the limit route PL as a curved linear object extending from the start point node Ns based on information of the set of coordinate positions (xₖ, yₖ). That is, the output block 120 displays the limit route PL by converting the coordinate positions (xₖ, yₖ) into positions on a display screen in the display system 7 and interpolating between the coordinate positions (xₖ, yₖ) with a curve.

Thereby, an input permitted area where input of the target route P is permitted, and an input prohibited area where input of the target route P is prohibited are displayed on the display system 7 with the limit route PL as a boundary line. The input permitted area can also be rephrased as a travel permitted area where traveling of the autonomous device 1 is permitted. Also, the input prohibited area can also be rephrased as a travel prohibited area where traveling of the autonomous device 1 is prohibited. Note that depending on the time step ds and the number of updates, the limit route PL may be displayed up to a termination within the display screen. In other words, the limit route PL may be displayed in a state of being interrupted within the display screen.

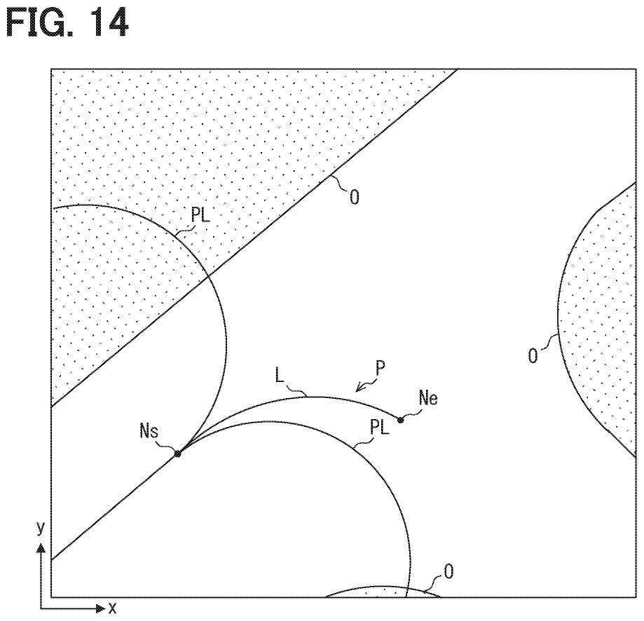

This flow proceeds to S60 after the process of S53. That is, the user inputs the end point node Ne while looking at the facility map on which the limit route PL is displayed, as shown in FIG. 14. When the target route P is defined in the process of S50, this flow proceeds to S61.

In S62, the acquisition block 110 determines whether the target route P input by the user crosses the limit route PL. If it is determined that the target route P crosses the limit route PL, this flow proceeds to S63. In S63, the output block 120 prohibits finalization of the target route P.

For example, the output block 120 prohibits input of a next target route P having the end point node Ne of the current target route P as the start point node Ns until a correction input for the target route P is made. The output block 120 may notify the user that the target route P crosses the limit route PL via the display system 7. After S63, this flow returns to S60. Thereby, the user corrects the target route P crossing the limit route PL by inputting the end point node Ne again. On the other hand, if it is determined in S62 that the target route P does not cross the limit route PL, this flow proceeds to S70. Note that in S70 in the present embodiment, the set speed Vs defining the limit route PL may be acquired as the target speed Vi.

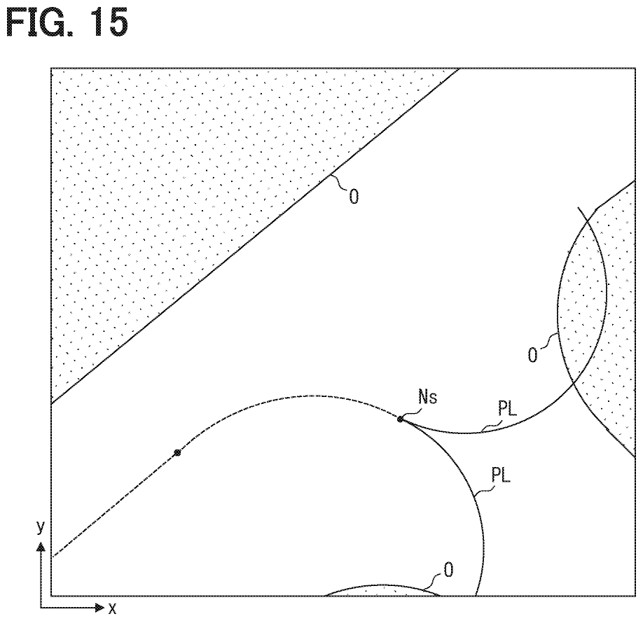

Also, in the present embodiment, after the end point node Ne of the target route P input immediately before is defined as the next start point node Ns in S130, this flow proceeds to S52. That is, every time a target route P that does not cross the limit route PL and has no non-permission section S is input, the limit route PL extending from the end point node Ne of the input target route P is displayed as a guide when inputting a new target route P (see FIG. 15).

According to the third embodiment described above, the limit route PL correlated with the yaw rate limit value γₘₐₓ assumed for the autonomous device 1 as the upper limit within the permission range where tracing is established, and the set speed Vs, is displayed. Therefore, by referring to this limit route PL, the user can input the target route P while checking whether the tracing of the target route P is established. Therefore, the actual traceability of the autonomous device 1 can be grasped not only after the user inputs the target route P but also before the input is completed.

### Fourth Embodiment

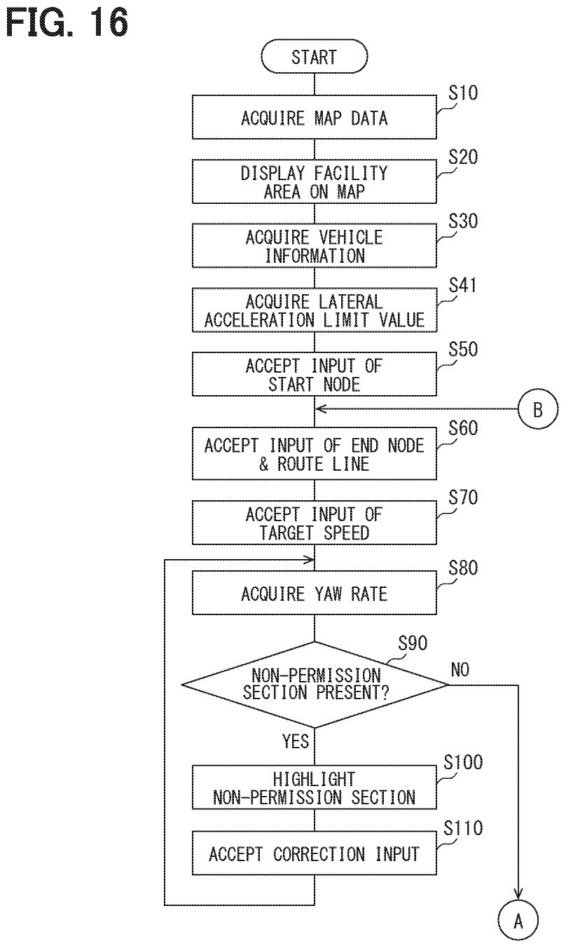

As shown in FIG. 16, a fourth embodiment is a modification of the first embodiment.

In the information processing device 100 of the fourth embodiment, this flow proceeds to S41 after the process of S30 as shown in FIG. 16. In S41, the acquisition block 110 acquires a lateral acceleration limit value aₗₘₐₓ instead of the yaw rate limit value γₘₐₓ. After S41, this flow proceeds to S50.

In S90 of the present embodiment, the output block 120 determines presence or absence of the non-permission section S in a permission range correlated with the lateral acceleration limit value aₗₘₐₓ. The output block 120 converts the lateral acceleration limit value aₗₘₐₓ into the yaw rate limit value γₘₐₓ. Here, a relationship of the following eighth equation is established between the lateral acceleration limit value aₗₘₐₓ, and the target speed Vᵢ and the yaw rate limit value γₘₐₓ.

$${a}_{lmax} = {V}_{i} {γ}_{max} \qquad ( Eighth Equation )$$

Therefore, the output block 120 converts the lateral acceleration limit value aₗₘₐₓ into the yaw rate limit value γₘₐₓ as a value correlated with the target speed Vi based on the eighth equation. The output block 120 uses the magnitude of the yaw rate limit value γₘₐₓ converted from the lateral acceleration limit value aₗₘₐₓ as a parameter defining a threshold of the permission range. The output block 120 in S90 of the present embodiment determines the presence or absence of the non-permission section S in the permission range thus defined from the lateral acceleration limit value aₗₘₐₓ. That is, the yaw rate γᵢ outside the permission range in the present embodiment is a yaw rate γᵢ at which a lateral acceleration exceeds the lateral acceleration limit value aₗₘₐₓ in correlation with the curvature ρᵢ of the target route P and the target speed Vᵢ. The lateral acceleration limit value aₗₘₐₓ is an example of an “acceleration upper limit”.

In the fourth embodiment described above, the yaw rate γᵢ outside the permission range is a yaw rate γᵢ at which the lateral acceleration exceeds the lateral acceleration limit value aₗₘₐₓ in correlation with the target route P and the target speed Vᵢ. Therefore, if the autonomous device 1 travels the non-permission section S where the yaw rate γᵢ is outside the permission range, the lateral acceleration acting on the autonomous device 1 exceeds the lateral acceleration limit value aₗₘₐₓ. By highlighting and displaying this non-permission section S to the user, the user can avoid generating the target route P where lateral acceleration that causes trace failure acts on the autonomous device 1.

### Fifth Embodiment

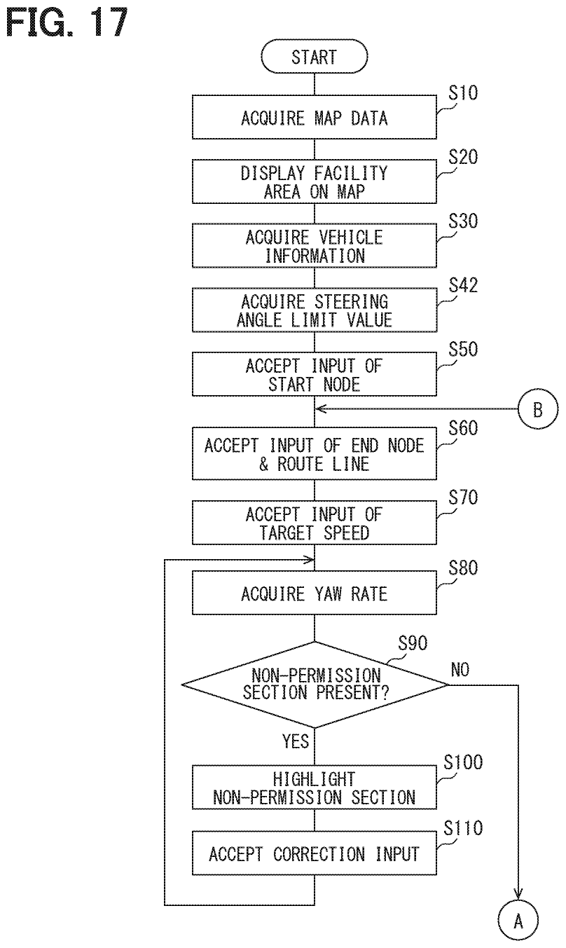

As shown in FIG. 17, a fifth embodiment is a modification of the first embodiment.

In the information processing device 100 of the fifth embodiment, this flow proceeds to S42 after the process of S30 as shown in FIG. 17. In S42, the acquisition block 110 acquires a steering angle limit value δₘₐₓ instead of the yaw rate limit value γₘₐₓ. After S42, this flow proceeds to S50.

In S80 of the present embodiment, the output block 120 determines presence or absence of the non-permission section S in a permission range correlated with the steering angle limit value δₘₐₓ. The output block 120 converts the steering angle limit value δₘₐₓ into the yaw rate limit value γₘₐₓ. Here, in the two-wheel model, a relationship of the following ninth equation is established between the steering angle limit value δₘₐₓ, and the target speed Vᵢ and the yaw rate limit value γₘₐₓ. Note that in the ninth equation, B is a wheelbase length of the autonomous device 1.

$${δ}_{max} = \frac{B}{{V}_{i}} {γ}_{max} \qquad ( Ninth Equation )$$

Therefore, the output block 120 converts the steering angle limit value δₘₐₓ into the yaw rate limit value γₘₐₓ as a value correlated with the target speed Vᵢ based on the ninth equation. The output block 120 uses the magnitude of the yaw rate limit value γₘₐₓ converted from the steering angle limit value δₘₐₓ as a parameter defining a threshold of the permission range. The output block 120 in S90 of the present embodiment determines the presence or absence of the non-permission section S in the permission range thus defined from the steering angle limit value δₘₐₓ. That is, the yaw rate γᵢ outside the permission range in the present embodiment is a yaw rate γᵢ at which a steering angle exceeds the steering angle limit value δₘₐₓ in correlation with the curvature ρᵢ of the target route P and the target speed Vᵢ. The steering angle limit value δₘₐₓ is an example of a “steering angle upper limit”.

In the fifth embodiment described above, the yaw rate γᵢ outside the permission range is a yaw rate γᵢ at which the steering angle exceeds the steering angle limit value δₘₐₓ in correlation with the target route P and the target speed Vᵢ. Therefore, if the autonomous device 1 travels the non-permission section S where the yaw rate γᵢ is outside the permission range, the steering angle acting on the autonomous device 1 exceeds the steering angle limit value δₘₐₓ. By highlighting and displaying this non-permission section S to the user, the user can avoid generating the target route P where the autonomous device 1 travels at a steering angle that causes trace failure.

### Sixth Embodiment

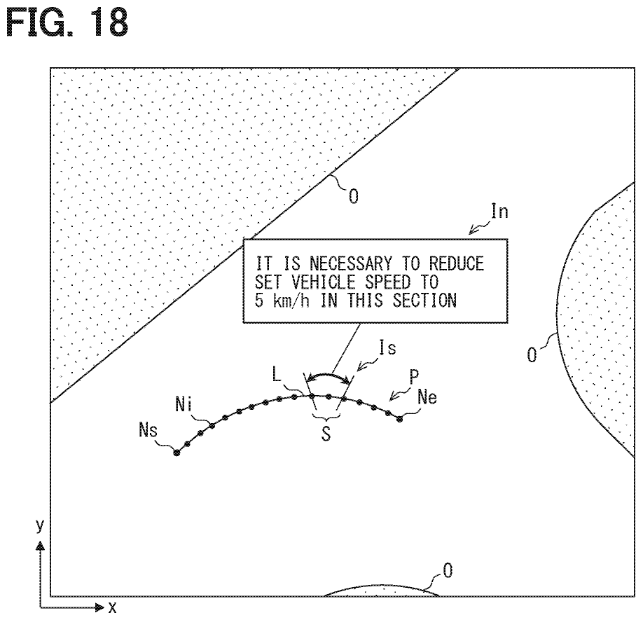

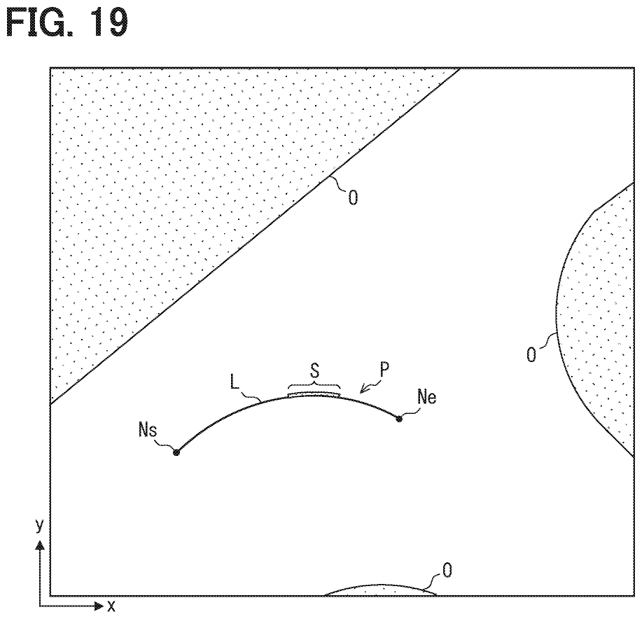

As shown in FIG. 18, a sixth embodiment is a modification of the first embodiment.

In highlighting and displaying the non-permission section S, the output block 120 of the sixth embodiment displays a display object indicating the non-permission section S by adding it to the target route P. For example, the output block 120 causes a section presentation image Is and a reduction notification image In to be displayed as shown in FIG. 18. The section presentation image Is is a display object other than the target route P that shows the non-permission section S in the target route P distinctively from the permission section. The section presentation image Is includes, for example, a linear division object dividing a boundary between the non-permission section S and the permission section, and an arrow-shaped range object arranged between the division objects and indicating a range of the non-permission section S. The reduction notification image In is a display object notifying that a reduction in the target speed Vᵢ is necessary for elimination of the non-permission section S. The reduction notification image In includes a text object that gives notification by text information such as, for example, “It is necessary to reduce set vehicle speed in this section to 5 km/h”.

### Seventh Embodiment

As shown in FIG. 19, a seventh embodiment is a modification of the first embodiment.

In highlighting the non-permission section S, the output block 120 of the seventh embodiment displays a display object proposing a reduction in the curvature ρᵢ of the non-permission section S by adding it to the target route P. For example, the output block 120 causes the non-permission section S to be displayed in a different display color with respect to other parts in the target route P. Note that in the example shown in FIG. 19, the different display color is represented by hatching. The output block 120 may display a notification image notifying the user by text information or the like that a reduction in the curvature ρᵢ is necessary, for example. By such highlighting, the output block 120 prompts the user to eliminate the non-permission section S by lowering the curvature ρᵢ.

Note that when proposing the reduction in the curvature ρᵢ, the acquisition block 110 in S110 accepts a change input of at least one of the position of the end point node Ne and the shape of the route line, and prohibits a change of the start point node Ns. Thereby, the acquisition block 110 avoids changing the shape of the target route P prior to the previous time in which the non-permission section S has already been eliminated.

According to the seventh embodiment described above, a change in curvature of the target route P is proposed in highlighting the non-permission section S. Therefore, it is possible to prompt the user to eliminate the non-permission section S by lowering the curvature ρᵢ.

### OTHER EMBODIMENTS

Although a plurality of embodiments have been described above, the present disclosure is not to be construed as being limited to those embodiments, and can be applied to various embodiments and combinations within a scope not departing from the gist of the present disclosure.

In a modification of the fourth embodiment, the information processing device 100 may convert the yaw rate γᵢ acquired in S80 into a lateral acceleration instead of converting the lateral acceleration limit value aₗₘₐₓ into the yaw rate limit value γₘₐₓ. In this case, the information processing device 100 determines that it is the non-permission section S when the lateral acceleration at each node is outside a permission range defined by the lateral acceleration limit value aₗₘₐₓ in S90. Similarly, in a modification of the fifth embodiment, the information processing device 100 may convert the yaw rate γᵢ acquired in S80 into a steering angle.

In a modification, the information processing device 100 may acquire a plurality of state values such as a yaw rate limit value, a lateral acceleration limit value, and a steering angle limit value. In this case, the information processing device 100 determines presence or absence of the non-permission section S according to a state value having the strictest permission range for trace feasibility among the plurality of state values. Specifically, the information processing device 100 may convert the lateral acceleration limit value aₗₘₐₓ and the steering angle limit value δₘₐₓ into yaw rates, and then select the strictest limit value among the respective state values as a state value defining the permission range.

In a modification, an input of the new target speed V may be accepted for each target route P. Also, in a modification, the information processing device 100 may accept an input of the target speed V that changes according to traveling from the start point node Ns.

In a modification, the computer constituting the information processing device 100 may include at least one of a digital circuit and an analog circuit as a processor. Here, the digital circuit is, for example, at least one type among an ASIC (Application Specific Integrated Circuit), an FPGA (Field Programmable Gate Array), an SOC (System on a Chip), a PGA (Programmable Gate Array), a CPLD (Complex Programmable Logic Device), and the like. Also, such a digital circuit may have a memory storing a program.

In a modification, the memory 101 in which the information processing program is stored may be a portable storage medium detachable from the information processing device 100. In this case, the memory 101 may be a storage medium for carrying the program to be installed in the information processing device 100, in which the information processing program is readably stored in the information processing device 100 as a computer. Alternatively, the memory 101 may be a storage medium of a server device that distributes the information processing program to the user's information processing device 100.

In addition to the forms described so far, the information processing device 100 in the above-described embodiments and modifications may be implemented in the form of a semiconductor device (for example, a semiconductor chip or the like).

What is claimed is:

1. An information processing method executed by a processor, the information processing method comprising:
executing a route generation related process related to generation of route data defining a target route to be traced by an autonomous device capable of autonomous traveling;
accepting an input of the target route targeted for each interval between a plurality of nodes defining a passing position of the autonomous device, and a target speed targeted in the autonomous traveling of the target route; and
causing a display device to display the target route,
wherein
causing the display device to display the target route includes highlighting and displaying a non-permission section in the target route where a yaw rate, which is assumed for the autonomous device tracing the target route having a curved shape in correlation with the target route and the target speed, falls outside a permission range permitting feasibility of tracing the target route.

2. The information processing method according to claim 1, wherein
the yaw rate outside the permission range includes a yaw rate at which a lateral acceleration exceeds an acceleration upper limit in correlation with the target route and the target speed.

3. The information processing method according to claim 1, wherein
the yaw rate outside the permission range includes a yaw rate at which a steering angle exceeds a steering angle upper limit in correlation with the target route and the target speed.

4. The information processing method according to claim 1, wherein
accepting the input of the target route and the target speed includes accepting an input of the target route as manual driving route data regarding a route in which the autonomous device actually travels by manual driving.

5. The information processing method according to claim 1, wherein
accepting the input of the target route and the target speed includes accepting an input of the target route designed by a manual input of the plurality of nodes by a user on a map regarding a travel area of the autonomous device displayed on the display device.

6. The information processing method according to claim 5, wherein
causing the display device to display the target route further includes causing the display device to display a curved limit route, which is a limit at which tracing of the target route by the autonomous device is permitted, from a manually input start point node of the target route among the plurality of nodes.

7. The information processing method according to claim 1, wherein
causing the display device to display the target route includes proposing a reduction in the target speed in the non-permission section in highlighting and displaying the non-permission section.

8. The information processing method according to claim 1, wherein
causing the display device to display the target route includes proposing a change in curvature of the target route in highlighting and displaying the non-permission section.

9. The information processing method according to claim 1, further comprising
generating the route data defining the target route in which the non-permission section is eliminated.

10. The information processing method according to claim 9, further comprising
outputting the route data defining the target route in which the non-permission section is eliminated.

11. An information processing device comprising
at least one of (i) a circuit and (ii) a processor with a memory storing computer program code executable by the processor, the at least one of the circuit and the processor configured to cause the information processing device to:
execute a route generation related process related to generation of route data defining a target route to be traced by an autonomous device capable of autonomous traveling;
accept an input of the target route targeted for each interval between a plurality of nodes defining a passing position of the autonomous device, and a target speed targeted in the autonomous traveling of the target route; and
cause a display device to display the target route,
wherein
causing the display device to display the target route includes highlighting and displaying a non-permission section in the target route where a yaw rate, which is assumed for the autonomous device tracing the target route having a curved shape in correlation with the target route and the target speed, falls outside a permission range permitting feasibility of tracing the target route.

12. A non-transitory computer-readable storage medium storing an information processing program including instructions to cause a processor to:
execute a route generation related process related to generation of route data defining a target route to be traced by an autonomous device capable of autonomous traveling;
accept an input of the target route targeted for each interval between a plurality of nodes defining a passing position of the autonomous device, and a target speed targeted in the autonomous traveling of the target route; and
cause a display device to display the target route,
wherein
causing the display device to display the target route includes highlighting and displaying a non-permission section in the target route where a yaw rate, which is assumed for the autonomous device tracing the target route having a curved shape in correlation with the target route and the target speed, falls outside a permission range permitting feasibility of tracing the target route.
